(19) United States
(12) Patent Application Publication
(10) Pub. No.: US 2008/0272318 A1
(43) Pub. Date: Nov. 6, 2008

(54) Radiation attenuating head cover

(75) Inventors: John A. Cadwalader, Overland Park, KS (US); William W. Orrison, Las Vegas, NV (US)

Correspondence Address: FOLEY & LARDNER LLP, 777 EAST WISCONSIN AVENUE, MILWAUKEE, WI, 53202-5306, US

(73) Assignee: Worldwide Innovations & Technologies, Inc.

(21) Appl. No.: 11/799,321

(22) Filed: May 1, 2007

(51) Int. Cl. G21F 3/02

(52) U.S. Cl. 250/516.1; 705/14

(57) ABSTRACT

A radiation attenuating head cover configured to at least partially cover a head of a user is disclosed. The radiation attenuating head cover includes a radiation attenuating portion positionable across a forehead of the user and extending in a vertical direction between an upper edge and a lower edge. The lower edge is configured to remain above the eyes and ears of the user. The radiation attenuating head cover also includes an attachment device for securing the radiation attenuation head cover to the user. The radiation attenuating portion is configured to protect the user from radiation during a radiological procedure.

### BACKGROUND

The present disclosure relates generally to systems for attenuating radiation and methods of providing a radiation attenuating product. More particularly, the present disclosure relates to systems for and methods of shielding the head of health care personnel from radiation during a radiological procedure and methods of providing a radiation attenuating head cover for health care personnel.

Radiation is used in a variety of medical procedures (generally referred to herein as “radiological procedures”) for diagnostic, therapeutic and/or surgical purposes. Radiation is a valuable tool, but one which may require certain safeguards due to the hazards associated therewith. Radiological procedures not only expose a patient to radiation, but often expose people near the patient (e.g., physicians, surgeons, technicians, nurses, etc.) to radiation (e.g., secondary or scatter radiation, etc.). Although the amount of radiation exposure that medical personnel receive during a single radiological procedure may not be harmful, medical personnel involved in a number of such procedures may suffer damage due to the cumulative effect of radiation.

It is known for medical personnel to wear a garment (e.g., vest, apron, etc.) covering their torso and formed of a radiation attenuating material to shield their bodies from radiation. However, the head of medical personnel is generally unprotected from radiation during such procedures. Research has shown that “[i]rradiation of the cranium, even at low doses, can increase the incidence of meningiomas by a factor of 10 and the incidence of glidal tumors by a factor of 3 to 7, with a latency period of 10 years to more than 20 years after exposure.” DeAngeles, Lisa M., M.D., Brain Tumors, N. Engl. J. Med., Vol. 344, No. 2 (Jan. 11, 2001).

It is known for medical personnel to wear a garment covering their heads during various medical procedures. Such known garments, often referred to generically as surgical caps, do not protect the users from having their heads irradiated, but rather, are worn for purposes of cleanliness and/or sterilization and are designed to provide protection against the transmission (giving or receiving) of germs, viruses or the like. Such known surgical caps are designed to cover the hair and adjacent head area of the user and generally formed of either a cloth fabric (if intended to be reusable) or a sterilized paper (if intended to be disposable).

Thus, there is a need for an improved radiation attenuation system for and method of shielding health care personnel from radiation during a radiological procedure. There is also a need for a radiation attenuation system that is configured to shield the head of health care personnel from radiation during a radiological procedure. There is further a need for a radiation attenuation system that is configured to shield the head of health care personnel from scatter radiation during a radiological procedure. There is further a need for a radiation attenuation system that is configured to shield the head of health care personnel that can be selectively adjusted to accommodate heads of various sizes. There is also a need for a radiation attenuation system that can be easily shipped and/or stored. There is also further a need to provide a method of marketing a radiation attenuation system that is configured to shield the head of health care personnel that allows a user to select a radiation attenuation system that this cost-effective for the intended application. There is further a need for radiation attenuation system addressing these, and/or any other need.

### SUMMARY

One exemplary embodiment relates to a radiation attenuating head cover configured to at least partially cover a head of a user. The radiation attenuating head cover includes a radiation attenuating portion positionable across a forehead of the user and extending in a vertical direction between an upper edge and a lower edge. The lower edge is configured to remain above the eyes and ears of the user. The radiation attenuating head cover also includes an attachment device for securing the radiation attenuation head cover to the user. The radiation attenuating portion is configured to protect the user from radiation during a radiological procedure.

Another exemplary embodiment relates to a radiation attenuating head cover including a body portion and a top portion. The body portion has a substantially horizontal orientation and is positionable across a forehead of a user. The body portion includes a first material formed of a radiation attenuation material. The top portion is coupled to the body portion and extends from an upper edge of the body portion to provide an enclosure for receiving the head of the user. The top portion is formed of a second material, the second material is formed of a relatively non-attenuating and breathable material. The radiation attenuating head cover also includes an attachment device coupled to the body portion for securing the radiation attenuating head cover to the user.

Another exemplary embodiment relates to a method of marketing a radiation attenuating head cover. The method includes the steps of providing a radiation attenuating head cover having body portion formed of a radiation attenuation material, offering the radiation attenuating head cover with the radiation attenuating material having a first radiation transmission attenuating factor, offering the radiation attenuating head cover with the radiation attenuating material having a second radiation transmission attenuating factor that is lower than the first radiation transmission attenuating factor, and setting a higher price for the radiation attenuating head cover with the first radiation transmission attenuating factor.

Another exemplary embodiment relates to a method of using a radiation attenuating head cover. The method includes the steps of positioning a radiation attenuating head cover at least partially around a head and manipulating an attachment means for securing the radiation attenuating head cover to the head. The radiation attenuating head cover includes a body portion formed of a radiation attenuation means and a top portion coupled to the body portion and extending from an upper edge of the body portion to provide an enclosure for receiving the head. The top portion is formed of a relatively non-attenuating and breathable material.

### BRIEF DESCRIPTION OF THE DRAWINGS

FIG. 1 is a front perspective view of a radiation attenuating head cover according to an exemplary embodiment.

FIG. 2 is a front view of the radiation attenuating head cover of FIG. 1.

FIG. 3 is a cross sectional view of the radiation attenuating head cover of FIG. 1 taken along a line 3-3 in FIG. 2.

FIG. 4 is a rear view of the radiation attenuating head cover of FIG. 1.

FIG. 5 is a side view of the radiation attenuating head cover of FIG. 1.

FIG. 6 is a top view of the radiation attenuating head cover of FIG. 1.

FIG. 7 is an inside view of a portion of the radiation attenuating head cover of FIG. 1 that has been expanded for exemplary purposes.

FIG. 8 is a block diagram showing a method of marketing a radiation attenuating head cover according to an exemplary embodiment.

### DETAILED DESCRIPTION

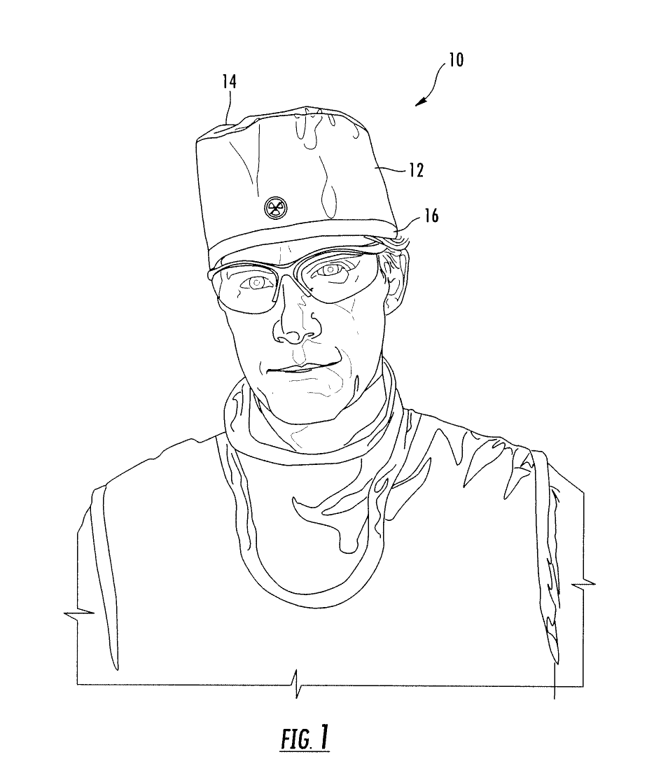

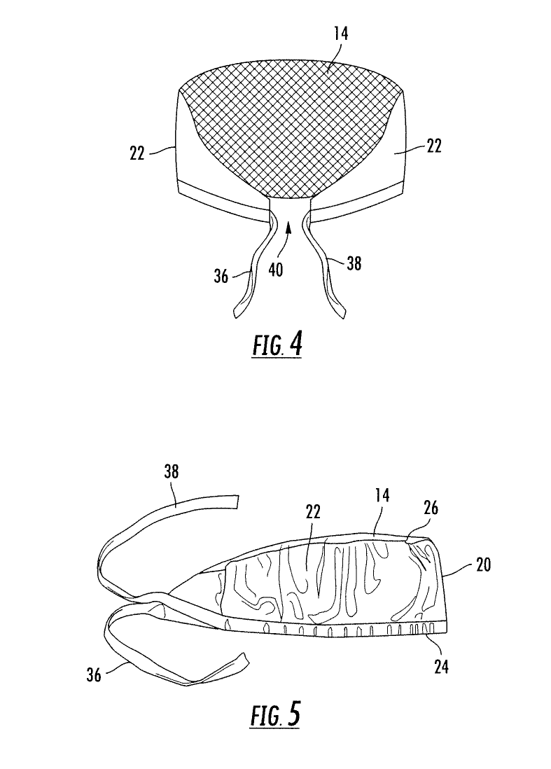

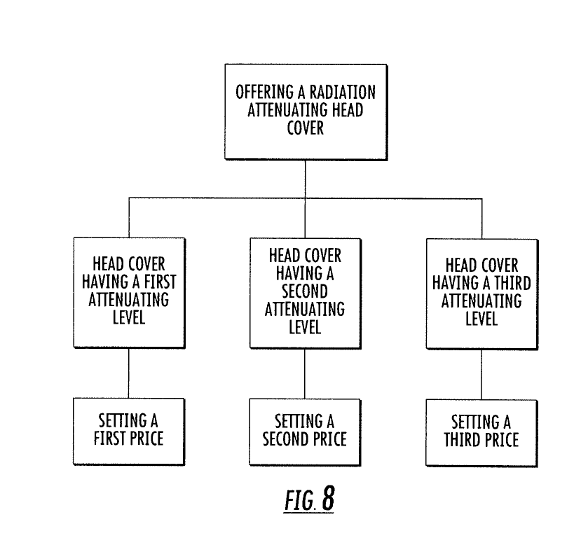

Referring generally to FIGS. 1 through 7, a radiation attenuating head cover (e.g., headpiece, cover, cap, hat, shield, etc.) is shown according to a non-exclusive exemplary embodiment. The radiation attenuating head cover includes one or more radiation barriers or shields supported in a manner and at a position that may be useful in attenuating (e.g., blocking, reflecting, absorbing, etc.) radiation generated during a radiological procedure that would otherwise irradiate the head of a user such as a physician, surgeon, technician, nurse, patient or any other health care personnel. For purposes of the present disclosure, the phrase “health care personnel” is used broadly to refer to surgeons, technicians, nurses and patients collectively, and any other person who may benefit from wearing the radiation attenuating head cover including, but not limited to patients.

The radiation attenuating head cover generally includes a body portion (shown in the drawings as a band portion 12) and an attachment mechanism or device (shown in the drawings as a tie back mechanism 16). The body portion is at least partially formed of a radiation attenuation material and is configured to be positioned between a radiation source and a portion of the head of the user. For example, the body portion may be configured to cover a front portion and/or a lateral side portion of the head of a user. The radiation attenuation material used for the body portion is generally light and flexible to maximize workability for bending, folding, reconfiguring, etc., or otherwise manipulating the body portion. The material may be formable (e.g. deformable) or compliant, and/or relatively “stretchable” (e.g. elastic).

According to an exemplary embodiment, the radiation attenuating head cover also includes a top portion (shown in the drawings as a crown portion 14). The top portion may or may not include a radiation attenuation material. According to an exemplary embodiment, the top portion is formed at least partially of a breathable material in an effort to keep the user comfortable during the radiological procedure. The attachment device is coupled to the body portion and/or the top portion and allows a user to adjust the size of the radiation attenuating head cover and/or selectively secure the radiation attenuating head cover to his or her head.

It should be noted that for purposes of this disclosure, the term “coupled” is used broadly to mean the joining or combining of two or more members (e.g., portions, layers, materials, components, etc.) directly or indirectly to one another. Such joining or combining may be relatively stationary (e.g., fixed, etc.) in nature or movable (e.g., adjustable, etc.) in nature. Such joining or combining may be achieved with the two members or the two members and any additional intermediate members being integrally formed as a single unitary body with one another (e.g., one-piece, etc.) or with the two members or the two members and any additional intermediate member being attached to one another. Such joining or combining may be intended to be relatively permanent in nature or alternatively may be intended to be relatively detachable or removable in nature.

According to an exemplary embodiment, the attenuation level of the radiation attenuation material used for the body portion and/or the top portion is selectable by a user so that the radiation attenuating head cover is appropriate for its intended use. In this way, the consumer (e.g., user, etc.) of the radiation attenuating head cover can obtain a radiation attenuating head cover is cost efficient while still providing a desired level of protection. Referring to FIG. 8, to provide for such optimization, a number of radiation attenuating head covers are offered to a consumer, each with a radiation attenuation material having a different attenuating factor. The cost of the radiation attenuating head covers are established based on the attenuating factor (e.g., a radiation attenuating head cover with a higher attenuating factor is priced greater than a radiation attenuating head cover with a lower attenuating factor, etc.). Since not all applications require the same attenuation level, providing several options to a consumer allows the select the radiation attenuating head cover that is suitable for a desired use and may encourage wider use of such head covers (particularly in low dose applications where medical personnel may not otherwise want to incur the cost of a relatively expensive head cover with a high attenuating factor).

It should be noted once again that the term health care personnel is used broadly herein and is intended to cover patients as well as physicians, surgeons, technicians and/or nurses. Further, the radiation attenuating head cover is suitable for use during any of a variety of radiological procedures. For example, the radiation attenuating head cover is suitable for use with diagnostic procedures (i.e., procedures allowing non-invasive examination or investigation of a patient such as x-ray examinations, Computed Tomography scanning procedures, or the like), therapeutic procedures (i.e., procedures wherein anatomical regions of a patient are irradiated as a treatment), and/or various invasive procedures in addition to those mentioned herein.

Referring to FIG. 1 in particular, the radiation attenuating head cover is shown according to an exemplary embodiment as a surgical cap 10 configured to be selectively worn by health care personnel. When worn by health care personnel during a radiological procedure, surgical cap 10 is configured to assist in maintaining a sterile environment while simultaneously protecting the head of the health care personnel from unnecessary exposure to radiation (e.g., secondary or scatter radiation, primary radiation, etc.). According to an exemplary embodiment, surgical cap 10 includes a first portion (e.g., base, body, side wall, etc.), shown as a band portion 12, and a fastening mechanism (e.g., sizing device, securing device, etc.), shown as a tie back mechanism 16.

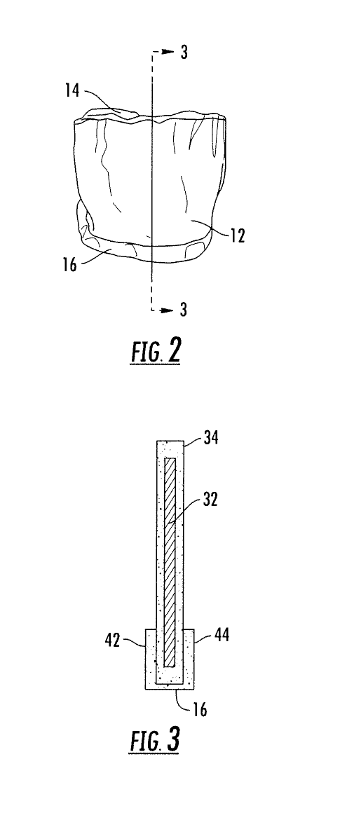

Band portion 12 and tie back mechanism 16 cooperate to provide a relatively lightweight, unrestrictive and/or selectively adjustable radiation attenuating head cover applicable for any of a variety of procedures. Referring to FIGS. 2 through 5, band portion 12 at least partially covers (e.g., encloses, conceals, etc.) a portion of the head of a user and is configured to attenuate radiation during the radiological procedure that would otherwise irradiate the head of a user. According to an exemplary embodiment, band portion 12 wraps around the head of a user in a generally horizontal direction to substantially encircle the head of a user.

According to the embodiment illustrated, band portion 12 includes a first region (e.g., primary region, etc.), shown as a front region 20 and a pair of second regions (e.g., lateral regions, secondary regions, etc.), shown as a pair of side regions 22. Front region 20 is positionable across the forehead of a user, while the pair of side regions 22 are positionable across the lateral sides of the head of the user. Depending on the diameter of the head of a user and the overall length of band portion 12, side regions 22 may extend partially, completely and/or not at all around the back of the user's head. According to the embodiment illustrated, front region 20 and side regions 22 of band portion 12 are integrally formed as a single, one-piece, unitary body, but alternatively, may be provided as separate members fastened together (e.g., sewn, adhered, welded, clipped, etc.).

Band portion 12 has a height extending vertically between a first or lower edge 24 and a second or upper edge 26 and a length extending horizontally between a first or left end 28 and a second or right end 30. Depending on various design criteria (e.g., desired size, shape, etc), the height of band portion 12 may vary along the length, or alternatively, may remain generally constant. According to the embodiment illustrated, lower edge 24 is a substantially straight edge that is generally parallel with upper edge 26 at least in front region 20. For such an embodiment, the height between lower edge 24 and upper edge 26 at front region 20 is between approximately 1 inch and approximately 6 inches. More particularly, the height is between approximately 3 inches and approximately 4 inches. According to the various alternative embodiments, the height of band portion 12 at front region 20 may be greater or less than the dimensions provided herein.

According to an exemplary embodiment, the height of band portion 12 does not remain constant from left end 28 to right end 30 but rather is reduced (e.g., generally tapered, etc.) at side portions 22 relative to lower edge 24 to facilitate a more precise fit of surgical cap 10 for the user. According to the embodiment illustrated, upper edge 26 is angled (e.g., sloped, etc.) downward relative to lower edge 24 at side portions 22. For example, upper edge 26 is shown as diverging toward lower edge 24 as upper edge 26 moves outward away from front portion 20 toward left end 28 and right end 30 respectively. Upper edge 26 may extend downward in a relatively continuous and linear manner along side regions 22 (as shown), or alternatively may extend discontinuously and/or curvilinearly along side regions 22.

According to an exemplary embodiment, the height ratio between front portion 20 and side portions 22 at left end 28 and right end 30 respectively is approximately 4 to 1. In the situation where the height of band portion 12 at front portion 20 is approximately 4 inches, the height of band portion 12 at left end 28 and right end 30 is approximately 1 inch. According to the various alternative embodiments, the height ratio between the front portion and the ends may be greater or less than 4 to 1.

According to an exemplary embodiment, lower edge 24 of band portion 12 is configured to be positioned generally above the eyes and/or ears of the user. Such positioning advantageously avoids interfering with the vision and/or hearing of the health care personnel wearing surgical 10 while still providing substantial protection from radiation exposure. According to the various alternative embodiments, lower edge 24 may include one or more curved portions to better conform to the head of the user. For example, lower edge 24 may include cutouts or inwardly curved portions at side portions 22 that are configured to receive the ears of the user. According to further various alternative embodiments, lower edge 24 may extend beyond and at least partially cover the eyes and/or ears of the user.

Referring to FIG. 3, band portion 12 includes a radiation barrier or shield layer 32 for attenuating radiation and protecting the head of the user. Shield layer 32 may be fabricated of any radiation attenuation material including, but not limited to, bismuth, barium, lead, tungsten, antimony, copper tin, aluminum, iron, iodine, cadmium, mercury, silver, nickel, zinc, thallium, tantalum, tellurium, and uranium. Anyone of the aforementioned radiation attenuation materials alone or in a combination of two or more of the radiation attenuation materials may provide the desired level of radiation attenuation. According to an exemplary embodiment, the radiation attenuating material is comprised of a polymeric matrix charged with an attenuating filler. Examples of suitable radiation attenuation materials are disclosed in U.S. Pat. No. 4,938,233, entitled “Radiation Shield,” and U.S. Pat. No. 6,674,087, entitled “Radiation Attenuation System,” both of which are hereby incorporated by reference in their entirety. It should be noted that radiation shield layer 32 is not limited to such radiation attenuating materials, and according to the various alternative embodiments, may be formed of any suitable radiation attenuating material including more conventional attenuating materials (e.g., lead-based materials, etc.).

The radiation transmission attenuation factor of radiation shield layer 32 may vary depending upon the intended application of surgical cap 10 and/or the number of layers of the attenuating members is provided. According to one exemplary embodiment, the radiation attenuating material has a radiation transmission attenuation factor of a percent (%) greater than about 50%, suitably greater than about 75%, suitably greater than about 90%, suitably greater than about 95% (with reference to a 90 kVp x-ray beam). According to various alternative embodiments, radiation attenuating material may have a radiation transmission attenuation factor of a percent less that 50% such as 10-50% or 10-20%. The radiation attenuating material may also at least partially attenuate gamma rays, and may have a gamma ray attenuation factor of at least 10% of a 140 keV gamma radiation source.

Radiation shield layer 32 may be in the form of a relatively thin and flexible film material, or alternatively, may be dispersed within another structure or applied as a coating (e.g., spray-on, etc.). Radiation shield layer 32 may be provided along a substantial portion of body portion 12, or alternatively may be provided at limited locations therein. For example, radiation shield layer 32 may only be provided at front portion 20 of band portion 12.

Referring still further to FIG. 3, band portion 20 is also shown as including a covering 34 disposed about or containing radiation shield layer 32. Covering 34 may enhance processability, provide softness or comfort to a user, and/or may allow surgical cap 10 to be more easily cleaned and/or sanitized. Covering 34 is preferably made of a fabric material such as that of a surgical drape, but can also be made of a non-fabric material such as a plastic sheet, non-woven paper material, or any other material suitable for covering the radiation attenuating member. According to an exemplary embodiment, covering 34 is constructed from a front sheet or layer and a back sheet or layer that are coupled together at the periphery to enclose radiation shield layer 32.

Covering 34 may be configured so that it permanently encloses the radiation attenuating material, or alternatively may be configured so that the radiation attenuating material may be selectively removed. According to an alternative embodiment, surgical cap 10 may include a radiation attenuating material that is not enclosed by a covering 34. According to another alternative embodiment, surgical cap 10 may include a covering 34 that is integrally formed with a radiation shield layer 32.

To facilitate the selective adjust of surgical cap 10 and/or the securement of surgical cap 10 to a user, the fastening mechanism (e.g., sizing device, securing device, etc.) is provided. The fastening mechanism advantageously allows the same surgical cap 10 to suitably fit on users having differently sized heads. According to an exemplary embodiment, the fastening mechanism allows the diameter of band portion 12 to be selectively adjusted by the user. According to the embodiment illustrated, the fastening mechanism is shown as tie back mechanism 16.

Tie back mechanism 16 generally includes a first tie or strap member 36 supported at left end 28 of band portion 12 and a second tie or strap member 38 supported at right end 30 of band portion 12. A gap or space 40 generally separates left end 28 of band portion 12 from right end 30 of band portion 12. A user can selectively adjust the width of such gap by tying together first strap member 36 and second strap member 38. According to an exemplary embodiment, first strap member 36 and second strap member 38 are integrally formed as a one-piece unitary body. According to the embodiment illustrated, this unitary body extends around band portion 12 along lower edge 24. The body has a first portion 42 on an interior side of band portion 12 and a second portion 44 on an exterior side of band portion 12 (shown in FIG. 3). Disposed (e.g., sandwiched, coupled, etc.) between first portion 42 and second portion 44 is the radiation shield layer 32 and covering 34 (if being used). First portion 42 may be formed of a relatively absorbent material and may be configured as a sweat band to provide additional comfort to the user.

According to the various alternative embodiments, the fastening mechanism may be any of a variety of devices which allow for the selective adjustment and/or securement of the radiation attenuating head cover to the user. For example, the fastening mechanism may be an elastic member supported around the periphery of the body portion and biased towards a tight fitting position. Further, the fastening mechanism may include the combination of a strap and a buckle wherein the strap can be selectively latched by the buckle a one or more positions. Also, the fastening mechanism may include one or more hook and loop fasteners spaced about the radiation attenuating head cover. Further still, the fastening mechanism may be any mechanical fastener, adhesive, etc. suitable for adjusting and/or securing the radiation attenuating head cover to a user. According to a still further alternative embodiment, a fastening mechanism may not be provided and the radiation attenuating head cover may configured to fit a specifically sized head.

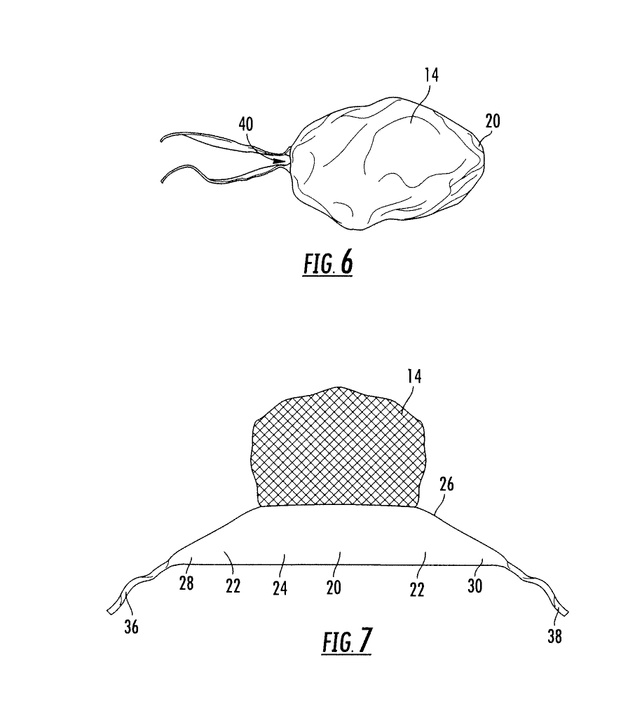

Referring further to FIGS. 1 and 5, surgical cap 10 is further shown as including a second portion (e.g., top, cover, etc.), shown as a crown portion 14 coupled to upper edge 26 of band portion 12. Crown portion 14 is configured to at least partially cover the top of a user's head. According to an exemplary embodiment, crown portion 14 is formed of a ventilated or otherwise breathable material relative to the radiation attenuating portion of band portion 12 to provide additional comfort to the user. Crown portion 14 may be formed of any of a variety of breathable materials including, but not limited to, a knitted or woven cloth, surgical cloth, paper, grid, web, etc. According to the various alternative embodiments, crown portion 14 may be formed entirely of a radiation attenuating material to provide additional protection for the user or may include one or more segments or portions of a radiation attenuating material.

For any of the embodiments described herein, one or more portions of surgical cap 10 (e.g., shield layer 32, covering 34, etc.) may be generally disposable in whole or in part, thereby minimizing ancillary sources of contamination that may arise from multiple uses. According to another suitable embodiment, one or more of the components of surgical cap 10 are generally non-toxic, recyclable, and/or biodegradable. According to an alternative embodiment, one or more of the components of surgical cap 10 may be reusable. According to a preferred embodiment, one or more of the components of surgical cap 10 may be sterilized between uses to minimize the likelihood of bacteriological or virus contamination. Sterilization may be performed in any convenient manner, including gas sterilization and irradiation sterilization.

Referring to FIG. 8, a block diagram showing a method of marketing a radiation attenuation head cover according to an exemplary embodiment is shown. The cost of a radiation attenuation product is related (e.g., directly, proportionately, dependent, etc.) to the radiation attenuation factor of the radiation attenuation material used for the radiation attenuation product. The greater the radiation attenuation factor, the greater the cost. For example, surgical caps 10 may be offered having the following radiation attenuation levels (with reference to a 90 kVp x-ray beam): 95 percent, 90 percent, 75 percent, 50 percent and 25 percent. For such an embodiment, the difference in price between the various steps in radiation attenuation levels may be between approximately 20 percent and 60 percent. For example, a surgical cap 10 having a 95 percent radiation attenuation level may be priced between approximately 30 percent and approximately 40 percent greater than a surgical cap 10 having a 90 percent radiation attenuation level. Further, the surgical cap 10 having a 90 percent radiation attenuation level may be priced between approximately 30 percent and approximately 40 percent of a surgical cap 10 having a 75 percent radiation attenuation level. According to the various alternative embodiments, surgical caps 10 having any of a variety of radiation attenuations levels may be provided and price differential between the steps may be greater or less the 20 to 60 percent.

It is important to note that the construction and arrangement of the elements of the radiation attenuation system as shown in the illustrated embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, or the length or width of the structures and/or members or connectors or other elements of the system may be varied. It should be noted that the elements and/or assemblies of the system may be constructed from any of a wide variety of materials that provide sufficient strength or durability, in any of a wide variety of colors, textures and combinations. For example, the radiation attenuation material may be a relatively flexible material, or alternatively, may be a relatively rigid material. Further, the head cover may include a fenestration area if the head cover going to be used on a patient during an invasive procedures. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A radiation attenuating head cover configured to at least partially cover a head of a user, the radiation attenuating head cover comprising:
a radiation attenuating portion positionable across a forehead of the user and extending in a vertical direction between an upper edge and a lower edge, the lower edge being configured to remain above the eyes and ears of the user; and
an attachment device for securing the radiation attenuation head cover to the user,
wherein the radiation attenuating portion is configured to protect the user from radiation during a radiological procedure.

2. The radiation attenuating head cover of claim 1, wherein the radiation attenuating portion is in the form of a band configured to extend in a generally horizontal direction substantially around the head of the user and cover a lateral side portion of the head of the user.

3. The radiation attenuation system of claim 1, further comprising a top portion supported at the upper edge of the radiation attenuating portion and substantially enclosing a top of the head of the user.

4. The radiation attenuation system of claim 3, wherein the top portion is at least partially formed of a relatively breathable material to provide ventilation for the user.

5. The radiation attenuation system of claim 3, wherein the top portion includes a radiation attenuating material.

6. The radiation attenuating head cover of claim 1, wherein the radiation attenuating portion includes of a radiation attenuating material that is substantially non-lead.

7. The radiation attenuating head cover of claim 1, further comprising a cover enclosing the radiation attenuating portion, the cover being formed of a relatively non-attenuating material.

8. The radiation attenuating head cover of claim 1, wherein the attachment device includes a pair of straps coupled at a rear portion of the cover, the straps being configured to tie together to secure the radiation attenuating head cover to the user.

9. A radiation attenuating head cover comprising:
a body portion having a substantially horizontal orientation and positionable across a forehead of a user, the body portion including a first material formed of a radiation attenuation material;
a top portion coupled to the body portion and extending from an upper edge of the body portion to provide an enclosure for receiving the head of the user, the top portion formed of a second material, the second material being formed of a relatively non-attenuating and breathable material; and
an attachment device coupled to the body portion for securing the radiation attenuating head cover to the user.

10. The radiation attenuating head cover of claim 9, wherein the body portion is configured to substantially encircle the head of the user.

11. The radiation attenuating head cover of claim 9, wherein the body portion further comprises a lower edge that is a substantially straight edge configured to be supported above the eyes and ears of the user.

12. The radiation attenuating head cover of claim 11, wherein a vertical distance between the upper edge and the lower edge remains substantially constant along a front portion of the body portion.

13. The radiation attenuating head cover of claim 12, wherein the upper edge extends downward towards the lower edge at a back portion of the body portion.

14. The radiation attenuating head cover of claim 9, further comprising a cover substantially enclosing the first material, the cover being formed of a third material, the third material being a relatively non-attenuating material.

15. The radiation attenuating head cover of claim 14, wherein the third material is a softened and absorbent material.

16. The radiation attenuating head cover of claim 9, wherein the attachment device includes a first strap provided at a first free end of the body portion and a second strap provided at a second free end of the body portion, the first strap is configured to be selectively tied with the second strap.

17. The radiation attenuating head cover of claim 9, wherein the first material has a radiation transmission attenuation factor of about 75 percent with reference to a 90 kVp x-ray beam.

18. The radiation attenuating head cover of claim 17, wherein the first material has a radiation transmission attenuating factor of about 95 percent with reference to a 90 kVp x-ray beam.

19. A method of marketing a radiation attenuating head cover, the method comprising:
providing a radiation attenuating head cover having body portion formed of a radiation attenuation material;
offering the radiation attenuating head cover with the radiation attenuating material having a first radiation transmission attenuating factor;
offering the radiation attenuating head cover with the radiation attenuating material having a second radiation transmission attenuating factor that is lower than the first radiation transmission attenuating factor; and
setting a higher price for the radiation attenuating head cover with the first radiation transmission attenuating factor.

20. The method of claim 19, wherein the first radiation transmission attenuating factor is between approximately 90 percent and approximately 97 percent with reference to a 90 kVp x-ray beam.

21. The method of claim 20, wherein the second radiation transmission attenuating factor is between approximately 75 percent and approximately 90 percent with reference to a 90 kVp x-ray beam.

22. The method of claim 19, wherein the radiation attenuating head cover with the first radiation transmission attenuating factor is priced between approximately 20 percent and approximately 60 percent greater than the radiation attenuating head cover with the second radiation transmission attenuating factor.

23. The method of claim 19, further comprising the step of offering the radiation attenuating head cover with the radiation attenuating material having a third radiation transmission attenuating factor that is lower than the second radiation transmission attenuating factor and setting a higher price for the radiation attenuating head cover with the second radiation transmission attenuating factor than for the radiation attenuating head cover with the third radiation transmission attenuating factor.

24. The method of claim 23, wherein the third radiation transmission attenuating factor is between approximately 50 percent and approximately 75 percent with reference to a 90 kVp x-ray beam.

25. A method of using a radiation attenuating head cover, the method comprising:
positioning a radiation attenuating head cover at least partially around a head; and
manipulating an attachment means for securing the radiation attenuating head cover to the head;
wherein the radiation attenuating head cover includes a body portion formed of a radiation attenuation means and a top portion coupled to the body portion and extending from an upper edge of the body portion to provide an enclosure for receiving the head, the top portion being formed of a relatively non-attenuating and breathable material.
